(19) United States
(12) Patent Application Publication
(10) Pub. No.: US 2017/0311390 A1
(43) Pub. Date: Oct. 26, 2017

(54) HEATING ROLLER

(71) Applicant: Chin-Chun CHOU, Taichung City (TW)

(72) Inventor: Chin-Chun CHOU, Taichung City (TW)

(21) Appl. No.: 15/138,695

(22) Filed: Apr. 26, 2016

(51) Int. Cl. H05B 3/50; H05B 3/00; H05B 1/02

(52) U.S. Cl. CPC H05B 3/50; H05B 1/0291; H05B 3/0014

(57) ABSTRACT

A heating roller includes a cylindrical member and a winding. The cylindrical member has a cylindrical body forming first and second sides along an axial direction. Plural wiring holes penetrate the cylindrical body along the axial direction and are each open on the first and second sides. The winding has a conductive wire penetrating the wiring holes. The conductive wire extends in opposite directions through each two adjacent wiring holes and is connected to a power source. Alternatively, the heating roller includes two windings each having plural conductive wires penetrating the corresponding wiring holes, wherein the conductive wires of one of the windings are connected to the positive and negative terminals of the power source at the first and second sides respectively, whereas the conductive wires of the other winding are connected to the negative and positive terminals of the power source at the first and second sides respectively.

### BACKGROUND OF THE INVENTION

### 1. Technical Field

The present invention relates to rollers and more particularly to a roller configured for heating.

### 2. Description of Related Art

The conventional heating rollers are typically provided with a spiral coil, and in order to accommodate the spiral coil, a hollow receiving space is required, which nevertheless inconveniences manufacture and assembly. Moreover, a spiral coil tends to result in uneven, slow, and inefficient heating, which demands improvement.

The foregoing drawbacks of the conventional heating rollers have yet to be overcome.

### BRIEF SUMMARY OF THE INVENTION

In light of the above, the primary objective of the present invention is to provide a heating roller which features easy manufacture, structural simplicity, and high heating efficiency.

To achieve this objective, the present invention provides a heating roller which includes a cylindrical member and a winding. The cylindrical member has a cylindrical body and a plurality of wiring holes. The cylindrical body forms a first side and a second side along an axial direction. Each of the wiring holes extends through the cylindrical body along the axial direction and is open on the first side and the second side. The winding has at least one conductive wire penetrating (i.e., extending through) the wiring holes of the cylindrical member. More specifically, the conductive wire extends in opposite directions through each two adjacent ones of the wiring holes of the cylindrical member and is connected to a power source.

To achieve the foregoing objective, the present invention also provides a heating roller which includes a cylindrical member and two windings. The cylindrical member has a cylindrical body and a plurality of wiring holes. The cylindrical body forms a first side and a second side along an axial direction. Each of the wiring holes extends through the cylindrical body along the axial direction and is open on the first side and the second side. Each of the two windings has a plurality of conductive wires penetrating (i.e., extending through) the corresponding ones of the wiring holes of the cylindrical member. The conductive wires of one of the windings are connected to a positive terminal of a power source at the first side and to a negative terminal of the power source at the second side. The conductive wires of the other winding are connected to the negative terminal of the power source at the first side and to the positive terminal of the power source at the second side.

The heating rollers of the present invention are so designed that the current directions in each two adjacent wiring holes are opposite to each other and that, therefore, heating efficiency is increased by the heating eddy current generated between each two adjacent wiring holes.

Preferably, the cylindrical member has at least one annular groove corresponding to the wiring holes, and each of the wiring holes forms an opening at the bottom of the annular groove.

Preferably, the annular groove of the cylindrical member is circular.

Preferably, the distance between the centers of each two adjacent ones of the wiring holes is defined as an interval, the distance between the center of each wiring hole and the outer periphery of the cylindrical body is defined as a spacing, and the interval is greater than or equal to the spacing.

Preferably, each of the wiring holes is penetrated by a plurality of conductive wires.

Preferably, the same conductive wire extends through the same wiring hole multiple times.

Preferably, the cylindrical member is assembled from two or more cylindrical member components.

Preferably, each of the plural cylindrical member components of the cylindrical member is penetrated by a separate winding.

Preferably, a winding extends through the plural cylindrical member components of the cylindrical member.

The structures and features of the heating rollers provided by the present invention will be described in more detail below. As a person of ordinary skill in the art would understand, the detailed description and the specific embodiments provided herein are for illustrative purposes only and are not intended to be restrictive of the scope of the invention.

### BRIEF DESCRIPTION OF THE SEVERAL VIEWS OF THE DRAWINGS

FIG. 1 is a perspective view of a preferred embodiment of the present invention;

FIG. 2 is a front view of the preferred embodiment in FIG. 1;

FIG. 3 is an end view of the preferred embodiment in FIG. 1;

FIG. 4 is another end view of the preferred embodiment in FIG. 1;

FIG. 5 is an end view of another preferred embodiment of the present invention; and

FIG. 6 is another end view of the preferred embodiment in FIG. 5.

### DETAILED DESCRIPTION OF THE INVENTION

To start with, it should be pointed out that all the direction-related adjectives used herein, such as inner, outer, upper, and lower, refer to directions shown in the accompanying drawings.

Hereinafter, the technical content and features of the present invention are detailed with reference to certain embodiments in conjunction with the accompanying drawings.

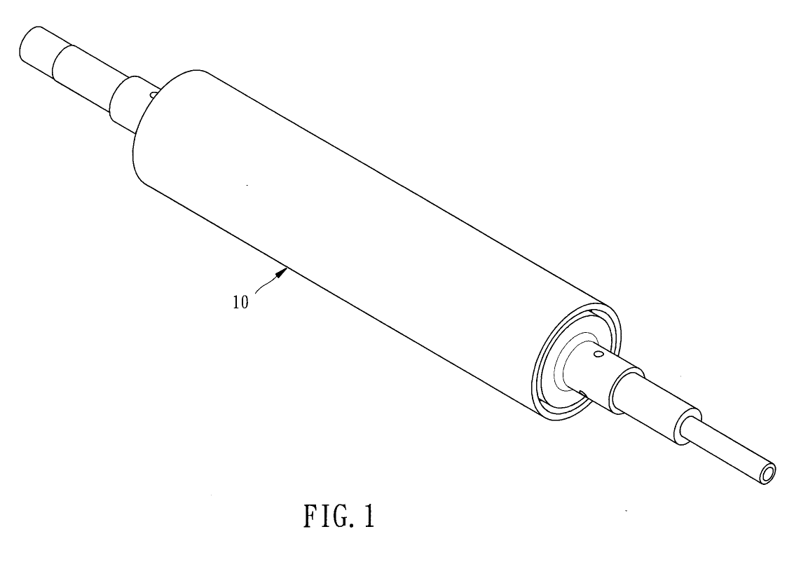

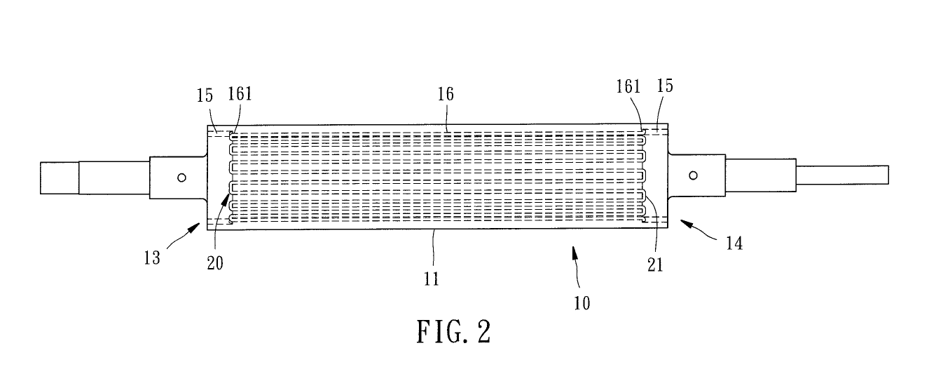

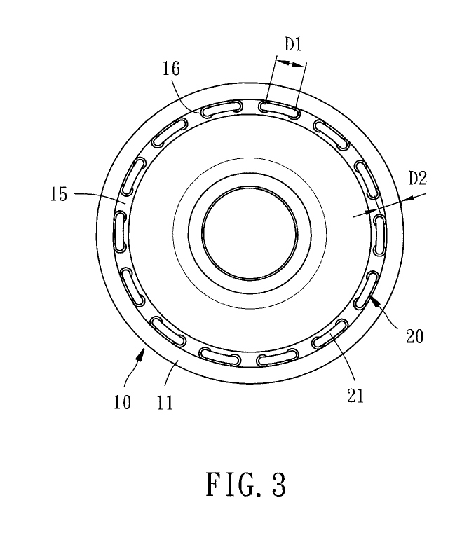

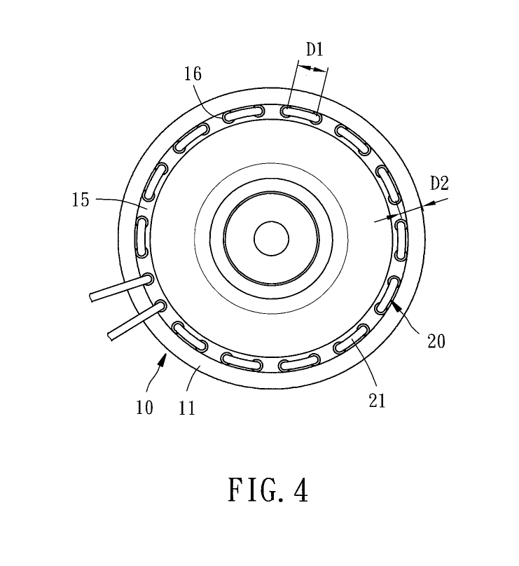

As shown in FIG. 1 to FIG. 4, the heating roller in a preferred embodiment of the present invention includes a cylindrical member 10 and a winding 20.

The cylindrical member 10 has a cylindrical body 11 which forms a first side 13 and a second side 14 along an axial direction.

The cylindrical member 10 further has two annular grooves 15 provided respectively at the first side 13 and the second side 14. The annular grooves 15 of the cylindrical member 10 are circular.

In addition, the cylindrical member 10 has a plurality of wiring holes 16 which are annularly arranged around the periphery of the cylindrical body 11 and penetrate the cylindrical body 11 in the axial direction. Each wiring hole 16 is open on the first side 13 and the second side 14.

More specifically, each wiring hole 16 opens at the bottoms of the two annular grooves 15. In other words, each wiring hole 16 forms an opening 161 at each annular groove 15.

That is to say, both annular grooves 15 of the cylindrical member 10 correspond to the wiring holes 16.

The distance between the centers of each two adjacent wiring holes 16 is defined as an interval D1, while the distance between the center of each wiring hole 16 and the outer periphery of the cylindrical body 11 is defined as a spacing D2. The interval D1 is greater than or equal to the spacing D2.

The winding 20 has a conductive wire 21 extending through, or penetrating, the wiring holes 16 of the cylindrical member 10. More specifically, the conductive wire 21 is inserted into the first side 13 and out of the second side 14 and then inserted into an adjacent wiring hole 16 in the second side 14. The wiring process continues in that order until the conductive wire 21 has passed through all the wiring holes 16. The present invention, however, is not limited to inserting the conductive wire sequentially into adjacent wiring holes.

In this preferred embodiment, the cylindrical member 10 has an even number of wiring holes 16. This allows the conductive wire 21 to run in opposite directions through each two adjacent wiring holes 16 and have its two ends coming out of the same side. Both ends of the conductive wire 21 are connected to a power source.

Furthermore, the conductive wire 21 may pass through each wiring hole 16 more than once, or each wiring hole 16 can be penetrated by a plurality of conductive wires 21.

In the heating roller described above, the conductive wire 21 extends in opposite directions through each two adjacent wiring holes 16 such that a heating eddy current is generated between each two adjacent wiring holes 16, through which the conductive wire 21 passes. Heating efficiency is thus increased, and the aforesaid objective of the present invention, achieved.

Besides, the structure described above allows easy control of the distance between each two adjacent wiring holes 16, so the heating effect can be adapted to practical needs conveniently.

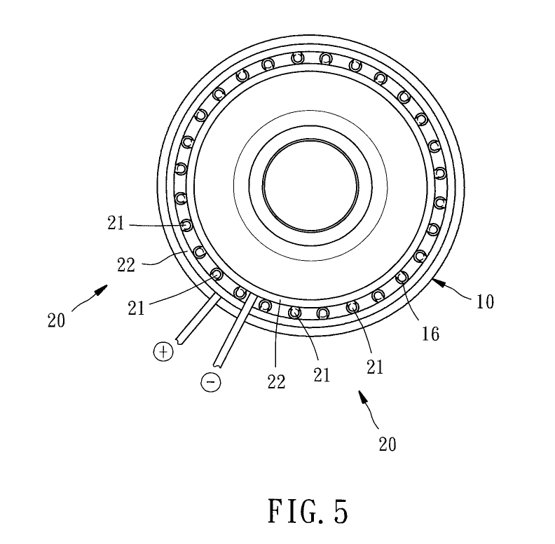

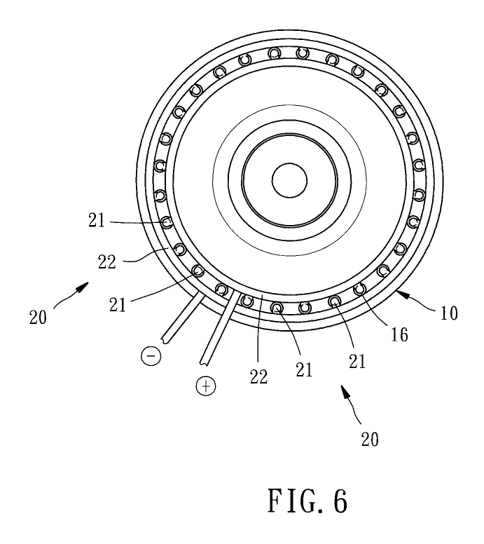

FIG. 5 and FIG. 6 show the heating roller in a second preferred embodiment of the present invention. The heating roller in this embodiment is generally the same as the one in the previous embodiment, except for the following:

The heating roller in the second preferred embodiment has two windings 20 each having a plurality of conductive wires 21 penetrating (i.e., extending through) alternate wiring holes 16 of the cylindrical member 10. Moreover, the conductive wires 21 of each winding 20 have their ends at each of the first side 13 and the second side 14 connected to a parallel connection element 22.

The first-side 13 parallel connection element 22 and the second-side 14 parallel connection element 22 of one of the windings 20 are connected to the positive and negative terminals of a power source respectively, whereas the first-side 13 parallel connection element 22 and the second-side 14 parallel connection element 22 of the other winding 20 are connected to the negative and positive terminals of the power source respectively. As a result, the electric current in the conductive wires 21 of the former winding 20 and that in the conductive wires 21 of the latter winding 20 flow in opposite directions.

The heating roller in this embodiment is so designed that the current directions in each two adjacent conductive wires 21 are opposite to each other, and because of that, a heating eddy current is generated between each two adjacent conductive wires 21, or between each two adjacent wiring holes 16, as in the previous embodiment. Thus, the objective of increasing heating efficiency is also achieved.

Aside from the embodiments described above, the present invention can be implemented as follows:

For example, each wiring hole 16 is penetrated by a plurality of conductive wires 21.

Or, the cylindrical member 10 is assembled from two or more cylindrical member components (hereinafter also referred to as cylindrical members 10), rather than being a single component.

In that case, each of the plural cylindrical members 10 can be penetrated by a separate winding 20, and the windings 20 penetrating respectively through the plural cylindrical members 10 can be the same or different from one another to provide different heating effects.

It is also feasible that a single winding 20 extends through the plural cylindrical members 10.

Any or a combination of the embodiments disclosed herein is equally capable of achieving the objective of the present invention.

According to the above, the heating rollers of the present invention are indeed easy to manufacture, simple in structure, and high in heating efficiency; therefore, the objective of the invention is achieved.

What is claimed is:

1. A heating roller, comprising:
a cylindrical member (10) having a cylindrical body (11) and a plurality of wiring holes (16), wherein the cylindrical body (11) forms a first side (13) and a second side (14) along an axial direction, and each of the wiring holes (16) extends through the cylindrical body (11) along the axial direction and is open on the first side (13) and the second side (14); and
a winding (20) having at least one conductive wire (21) extending through, i.e., penetrating, the wiring holes (16) of the cylindrical member (10), wherein the conductive wire (21) extends in opposite directions through each two adjacent ones of the wiring holes (16) of the cylindrical member (10) and is connected to a power source.

2. The heating roller of claim 1, wherein the cylindrical member (10) has at least one annular groove (15) corresponding to the wiring holes (16), and each of the wiring holes (16) forms an opening (161) at a bottom of the annular groove (15).

3. The heating roller of claim 2, wherein the annular groove (15) of the cylindrical member (10) is circular.

4. The heating roller of claim 1, wherein an interval (D1) is defined as a distance between centers of each two adjacent ones of the wiring holes (16), a spacing (D2) is defined as a distance between the center of each said wiring hole (16) and an outer periphery of the cylindrical body (11), and the interval (D1) is greater than or equal to the spacing (D2).

5. The heating roller of claim 1, wherein a said conductive wire (21) extends through a said wiring hole (16) multiple times.

6. The heating roller of claim 1, wherein each of the wiring holes (16) is penetrated by a plurality of said conductive wires (21).

7. The heating roller of claim 1, wherein the cylindrical member (10) is assembled from two or more cylindrical member components.

8. The heating roller of claim 7, wherein each of the two or more cylindrical member components of the cylindrical member (10) is penetrated by a separate said winding (20).

9. The heating roller of claim 7, wherein a said winding (20) extends through the two or more cylindrical member components of the cylindrical member (10).

10. A heating roller, comprising:
a cylindrical member (10) having a cylindrical body (11) and a plurality of wiring holes (16), wherein the cylindrical body (11) forms a first side (13) and a second side (14) along an axial direction, and each of the wiring holes (16) extends through the cylindrical body (11) along the axial direction and is open on the first side (13) and the second side (14); and
two windings (20) each having a plurality of conductive wires (21) extending through, i.e., penetrating, corresponding ones of the wiring holes (16) of the cylindrical member (10), wherein the conductive wires (21) of one of the windings (20) are connected to a positive terminal of a power source at the first side (13) and to a negative terminal of the power source at the second side (14), and the conductive wires (21) of the other winding (20) are connected to the negative terminal of the power source at the first side (13) and to the positive terminal of the power source at the second side (14).

11. The heating roller of claim 10, wherein the cylindrical member (10) has at least one annular groove (15) corresponding to the wiring holes (16), and each of the wiring holes (16) forms an opening (161) at a bottom of the annular groove (15).

12. The heating roller of claim 11, wherein the annular groove (15) of the cylindrical member (10) is circular.

13. The heating roller of claim 10, wherein an interval (D1) is defined as a distance between centers of each two adjacent ones of the wiring holes (16), a spacing (D2) is defined as a distance between the center of each said wiring hole (16) and an outer periphery of the cylindrical body (11), and the interval (D1) is greater than or equal to the spacing (D2).

14. The heating roller of claim 10, wherein a said conductive wire (21) extends through a said wiring hole (16) multiple times.

15. The heating roller of claim 10, wherein each of the wiring holes (16) is penetrated by a plurality of said conductive wires (21).

16. The heating roller of claim 10, wherein the cylindrical member (10) is assembled from two or more cylindrical member components.

17. The heating roller of claim 16, wherein each of the two or more cylindrical member components of the cylindrical member (10) is penetrated by a separate said winding (20).

18. The heating roller of claim 16, wherein a said winding (20) extends through the two or more cylindrical member components of the cylindrical member (10).
